(19) United States
(12) Patent Application Publication
(10) Pub. No.: US 2026/0189396 A1
(43) Pub. Date: Jul. 2, 2026

(54) Machine-Resistant Image Capture via Overclocked Image Feature Hashing and Dynamic Perceptual Obfuscation

(71) Applicant: Bank of America Corporation, Charlotte, NC (US)

(72) Inventors: Adam King, Fort Mill, SC (US); Peter Nein, Waxhaw, NC (US); Heather Denton, Charlotte, NC (US); Mark Davis-Ball, New York, NY (US); Wesley Hayes, Denver, CO (US); Roland Chan, Charlotte, NC (US)

(21) Appl. No.: 19/008,136

(22) Filed: Jan. 2, 2025

(51) Int. Cl. H04L 9/32; G06T 11/60

(52) U.S. Cl. CPC H04L 9/3236; G06T 11/60

(57) ABSTRACT

A computing platform may apply a microshift to an authentication image associated with a user. The computing platform may hash the microshifted authentication image to produce a modified authentication image. The computing platform may receive a request to authenticate the user, wherein the request includes an input image for identity verification. The computing platform may apply the microshift and the hash to the input image to produce a modified input image. The computing platform may compare the modified input image to the modified authentication image. Based on identifying a match, the computing platform may generate, using a neural network, a confidence score indicating a likelihood that the modified input image depicts the user. The computing platform may compare the confidence score to a confidence threshold. Based on identifying that the confidence score meets or exceeds the confidence threshold, the computing platform may authenticate the user.

### BACKGROUND

In some instances, facial recognition and/or other image recognition may be utilized for authentication. Such systems are, however, increasingly vulnerable to manipulation by deepfake technologies, which may replicate human likeness. They may create security issues in identity verification and authentication systems. For example, current systems might not reliably distinguish real humans from artificial intelligence (AI) generated images.

### SUMMARY

Aspects of the disclosure provide effective, efficient, scalable, and convenient technical solutions that address and overcome the technical problems associated with image based authentication. In accordance with one or more embodiments of the disclosure, a computing platform comprising at least one processor, a communication interface, and memory storing computer-readable instructions may apply a microshift to an authentication image associated with a user. The computing platform may hash the microshifted authentication image to produce a modified authentication image. The computing platform may receive a request to authenticate the user, where the request may include an input image for identity verification. The computing platform may apply the microshift and the hash to the input image to produce a modified input image. The computing platform may compare the modified input image to the modified authentication image. Based on identifying a match between the modified input image and the modified authentication image, the computing platform may generate, using a neural network, a confidence score indicating a likelihood that the modified input image depicts the user. The computing platform may compare the confidence score to a confidence threshold. Based on identifying that the confidence score meets or exceeds the confidence threshold, the computing platform may authenticate the user.

In one or more instances, applying the microshift may include modifying one or more of: pixel alignment, light refraction, or texture mapping. In one or more instances, the microshift may be detectable by machines, and imperceptible to a human eye.

In one or more examples, the computing platform may continue to hash, at a predetermined interval, the modified input image, where a record of the hashing may be maintained by the computing platform, and wherein further input images may be authenticated by applying the microshift and hashing to the further input images according to the record. In one or more examples, based on identifying that the modified input image fails to match the modified authentication image, the computing platform may execute one or more response actions.

In one or more instances, executing the one or more response actions may include causing the input image to degrade at a source of the input image. In one or more instances, based on identifying that the confidence score fails to meet or exceed the confidence threshold, the computing platform may execute one or more response actions.

In one or more examples, the input image may be one of: an image, a video recording, or a live video feed. In one or more examples, the computing platform may update, via a dynamic feedback loop and using the input image, the neural network. In one or more examples, the microshift may render the authentication image impossible to scan or replicate.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for using overclocked image feature hashing and dynamic perceptual obfuscation for machine resistant image capture in accordance with one or more example embodiments.

FIGS. 2A-2D depict an illustrative event sequence for using overclocked image feature hashing and dynamic perceptual obfuscation for machine resistant image capture in accordance with one or more example embodiments.

FIG. 3 depicts an illustrative method for using overclocked image feature hashing and dynamic perceptual obfuscation for machine resistant image capture in accordance with one or more example embodiments.

FIG. 4 depicts an illustrative user interface for using overclocked image feature hashing and dynamic perceptual obfuscation for machine resistant image capture in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to using overclocked image feature hashing and dynamic perceptual obfuscation for machine-resistant image capture. Digital images used for authentication, such as facial recognition systems, may be increasingly vulnerable to manipulation by AI-driven systems, like deepfake technologies, which may replicate or spoof images with high accuracy. Current systems may rely on static image capture methods, making them susceptible to malicious attempts to scan, download, or replicate the image data. There may be a need for a system that makes images resistant to machine interpretation and replication while remaining static to human observers for accurate authentication.

Described herein is an image capture system that dynamically shifts certain image features, imperceptible to humans but recognizable by machines, so that the image appears to computers as if it is constantly moving. By using overclocked image feature hashing combined with dynamic perceptual obfuscation, the system may prevent AI systems and deep fake generators from scanning or downloading the image effectively. While maintaining this obfuscation, the system may still allow the image to appear static and usable for human users during authentication processes.

This system uniquely combines cryptographic hashing with dynamic perceptual obfuscation to create images resistant to machine interpretation while remaining static to human users. Unlike existing facial recognition systems, which may rely on static images, this system may introduce subtle frame by frame changes, making it impossible for deepfake technologies or malicious AI systems to replicate or manipulate the image.

These and other features are described in greater detail below.

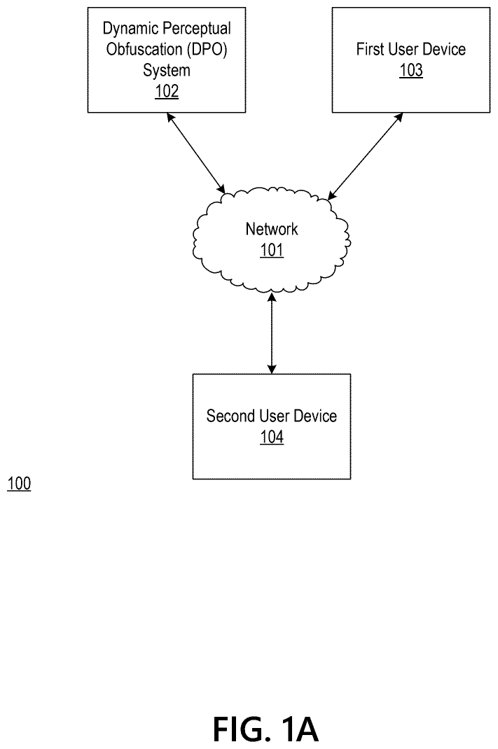

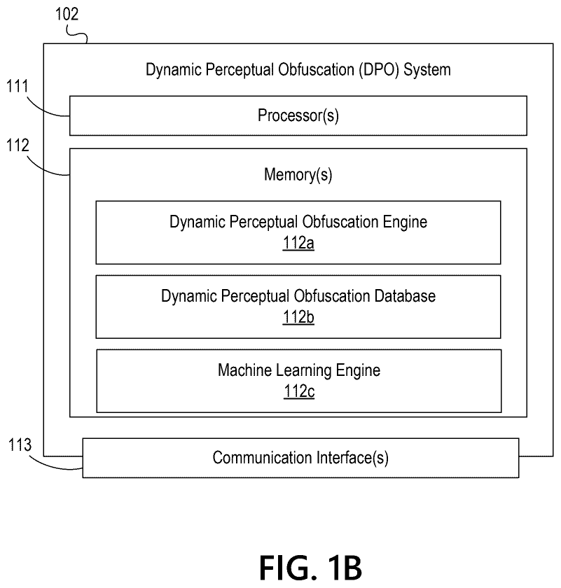

FIGS. 1A-1B depict an illustrative computing environment for using overclocked image feature hashing and dynamic perceptual obfuscation for machine resistant image capture in accordance with one or more example embodiments. Referring to FIG. 1A, computing environment 100 may include one or more computer systems. For example, computing environment 100 may include dynamic perceptual obfuscation (DPO) system 102, first user device 103, and second user device 104.

DPO system 102 may include one or more computing devices (servers, server blades, or the like) and/or other computer components (e.g., processors, memories, communication interfaces, or the like). For example, the DPO system 102 may be configured to apply and validate microshifts in authentication images for enhanced security. The DPO system 102 may further train, host, and apply a neural network for identity verification. In some instances, the DPO system 102 may be a stand alone system, which may integrate seamlessly with other authentication or facial recognition systems, or may be integrated into such authentication or facial recognition systems.

First user device 103 may be or include one or more devices (e.g., laptop computers, desktop computer, smartphones, tablets, and/or other devices) configured for use in providing images, recorded video, live video, and/or other inputs for authentication. For example, the first user device 103 may be configured to capture such inputs via an integrated or otherwise connected camera, and to provide such images to the DPO system 102 for verification. For illustrative purposes in the event sequence described below, it may be assumed that the first user device 103 may be operated by a legitimate user.

Second user device 104 may be or include one or more devices (e.g., laptop computers, desktop computer, smartphones, tablets, and/or other devices) configured for use in providing images, recorded video, live video, and/or other inputs for authentication. For example, the second user device 104 may be configured to capture such inputs via an integrated or otherwise connected camera, and to provide such images to the DPO system 102 for verification. For illustrative purposes in the event sequence described below, it may be assumed that the second user device 104 may be operated by an illegitimate or otherwise malicious user, who may, e.g., have intercepted one or more authentication images associated with a user of the first user device.

Computing environment 100 also may include one or more networks, which may interconnect DPO system 102, first user device 103, and second user device 104. For example, computing environment 100 may include a network 101 (which may interconnect, e.g., DPO system 102, first user device 103, and second user device 104).

In one or more arrangements, DPO system 102, first user device 103, and second user device 104 may be any type of computing device capable of receiving a user interface, receiving input via the user interface, and communicating the received input to one or more other computing devices, and/or training, hosting, executing, and/or otherwise maintaining one or more artificial intelligence models. For example, DPO system 102, first user device 103, second user device 104, and/or other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of DPO system 102, first user device 103, and second user device 104 may, in some instances, be special-purpose computing devices configured to perform specific functions.

Referring to FIG. 1B, DPO system 102 may include one or more processors 111, memory 112, and communication interface 113. A data bus may interconnect processor 111, memory 112, and communication interface 113. Communication interface 113 may be a network interface configured to support communication between DPO system 102 and one or more networks (e.g., network 101, or the like). Memory 112 may include one or more program modules having instructions that when executed by processor 111 cause DPO system 102 to perform one or more functions described herein and/or one or more databases that may store and/or otherwise maintain information which may be used by such program modules and/or processor 111. In some instances, the one or more program modules and/or databases may be stored by and/or maintained in different memory units of DPO system 102 and/or by different computing devices that may form and/or otherwise make up DPO system 102. For example, memory 112 may have, host, store, and/or include dynamic perceptual obfuscation engine 112a, dynamic perceptual obfuscation database 112b, and machine learning engine 112c. Dynamic perceptual obfuscation engine 112a may have instructions that direct and/or cause DPO system 102 to execute advanced techniques to protect and authenticate images. For example, the dynamic perceptual obfuscation engine 112a may be configured to introduce microshifts into images, which may subsequently be used for authentication. Dynamic perceptual obfuscation database 112b may store information that may be used by the DPO system 102 and/or dynamic perceptual obfuscation engine 112a to effectively generate, protect and authenticate images. Machine learning engine 112c may be configured to train, apply, refine, and/or otherwise maintain a neural network for use in verifying user identity.

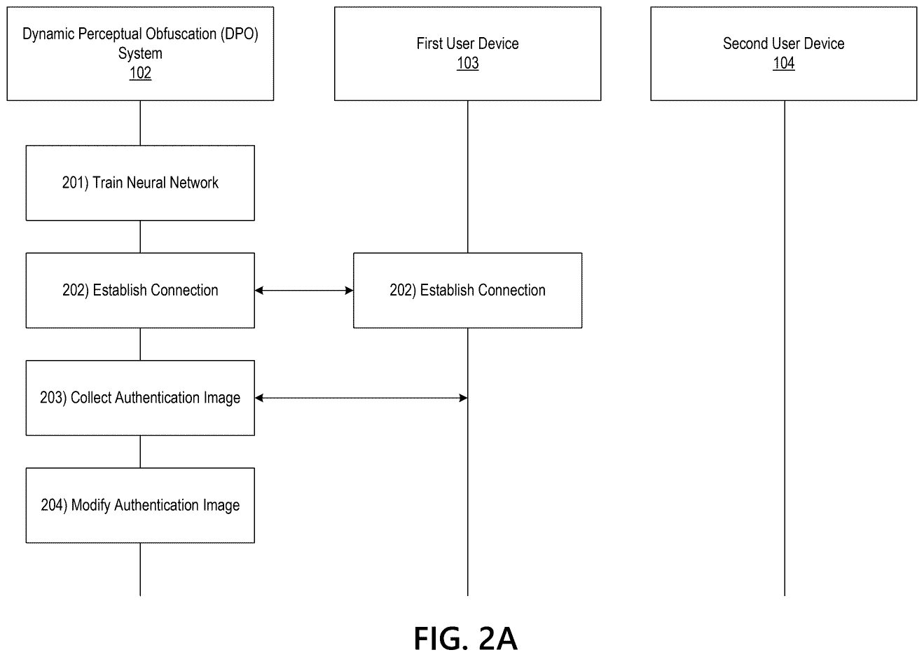

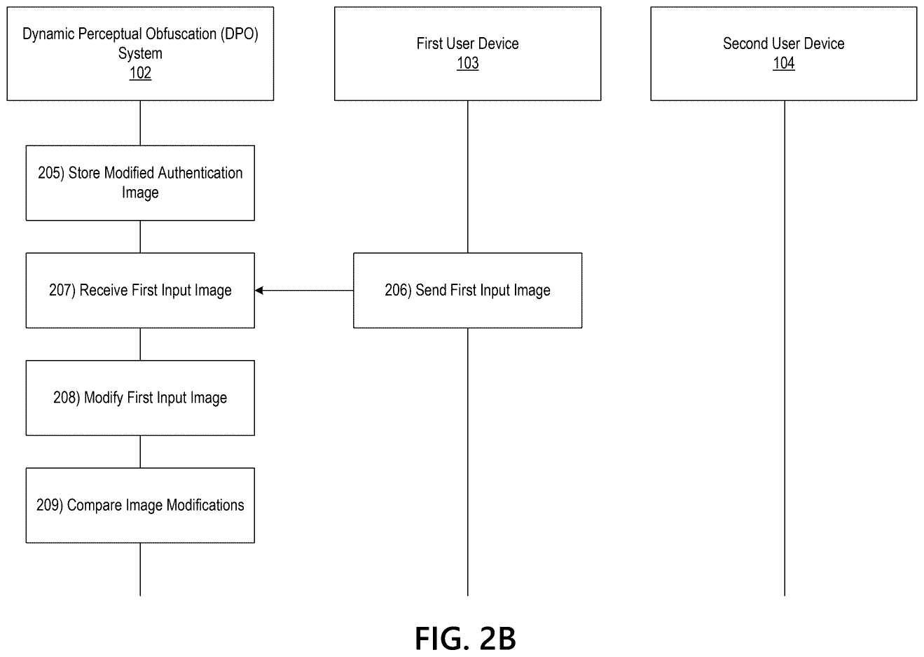

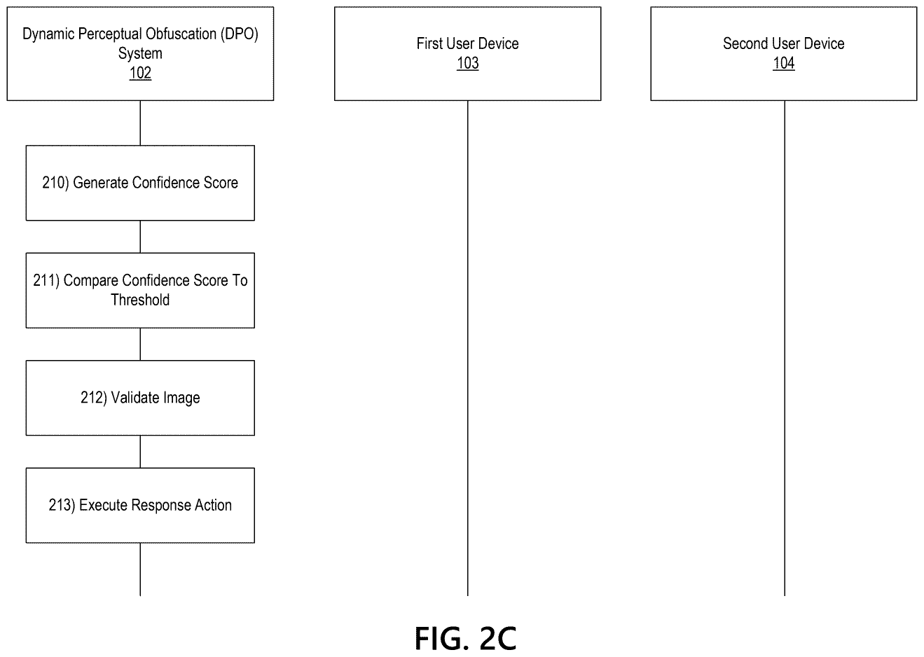

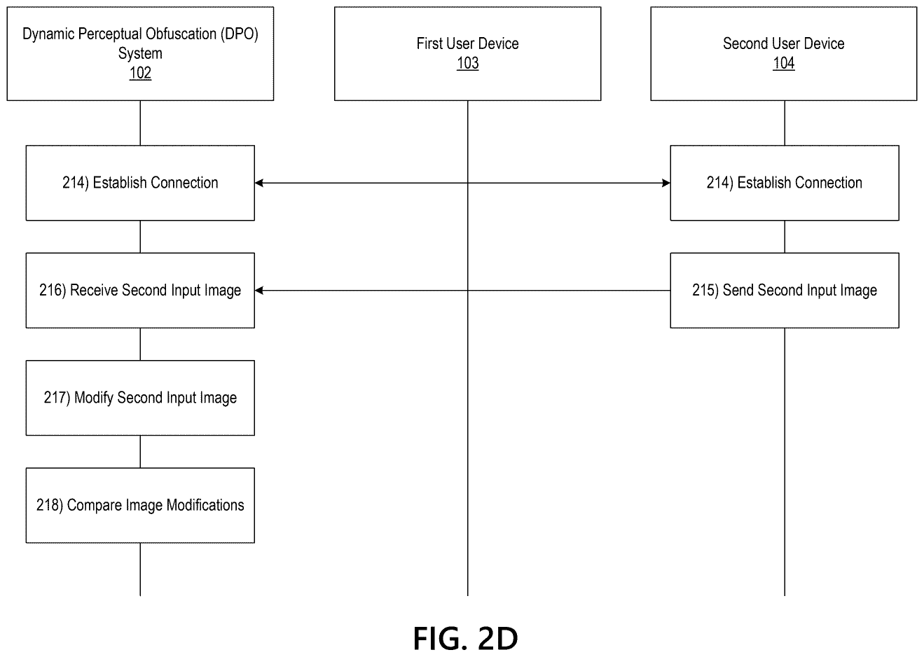

FIGS. 2A-2D depict an illustrative event sequence for using overclocked image feature hashing and dynamic perceptual obfuscation for machine resistant image capture in accordance with one or more example embodiments. Referring to FIG. 2A, at step 201, the DPO system 102 may train a neural network. For example, the DPO system 102 may train the neural network to produce confidence scores indicating, for a given input image, a likelihood that a subject, included in the input image, is validated. For example, the confidence scores may indicate that an individual is accurately represented in the input image, or the like based on one or more facial recognition techniques.

In some instances, to perform such training, the DPO system 102 may feed a plurality of training images into the neural network, which may, in some instances, be labeled based on a corresponding subject of the training images. In doing so, the DPO system 102 may generate stored correlations between training images and the corresponding subjects, which may, e.g., be used to ultimately generate the confidence scores. In some instances, rather than independently training the neural network, the DPO system 102 may implement a pre-trained neural network, which may, e.g., be configured for facial recognition, image processing, or the like.

At step 202, the DPO system 102 may establish a connection with the first user device 103. For example, the DPO system 102 may establish a first wireless data connection with the first user device 103 to link the DPO system 102 with the first user device 103 (e.g., in preparation for collecting authentication images, or the like). In some instances, the DPO system 102 may identify whether a connection is already established with the first user device 103. If a connection is already established with the first user device 103, the DPO system 102 might not re-establish the connection. Otherwise, if a connection is not yet established with the first user device 103, the DPO system 102 may establish the first wireless data connection as described herein.

At step 203, the DPO system 102 may collect an authentication image from the first user device 103. For example, the first user device 103 may capture an image, a series of images, a video recording, live video footage, and/or other inputs, which may, e.g., be used to validate an identity of a user of the first user device 103. The DPO system 102 may then obtain the authentication image from the first user device 103.

At step 204, the DPO system 102 may apply one or more microshifts to the authentication image. For example, the DPO system 102 may apply microshifts in pixel alignment, light refraction, texture mapping, and/or other characteristics to the authentication image. In some instances, these shifts may be too small for the human eye to perceive, but they may be noticeable to machines. In some instances, the DPO system 102 may activate to apply such microshifts upon activation of the image capture at step 203.

In some instances, once the microshift has been applied, the DPO system 102 may generate cryptographic hashes for each frame of the authentication image, which may uniquely identify each subtly different frame. In some instances, the DPO system 102 may dynamically update the hash with each new frame, which may, e.g., make the authentication image appear to computers as if it is constantly in motion (e.g., similar to a low frame rate graphics interchange format (GIF)).

In some instances, the DPO system 102 may apply these shifts in real time, which may, e.g., make the authentication image difficult to download, scan, replicate, or otherwise interpret by malicious AI systems, deepfake technologies, or the like, which may, e.g., rely on static images for replication. For example, although the image may appear static to a user, it may appear dynamic to any computer trying to copy it (i.e., a deepfake system or other malicious artificial intelligence system attempting to replicate the face might not be able to copy the image due to the ongoing changes, which may prevent a successful spoofing attempt).

Referring to FIG. 2B, at step 205, the DPO system 102 may store the modified authentication image. This may result in a modified authentication image, which may, e.g., be used to validate and/or otherwise authenticate the user going forward. In some instances, the DPO system 102 may continue to hash the modified authentication image (e.g., at a predetermined interval or otherwise), and may store each iteration of the hashing. In doing so, the DPO system 102 may preserve a historical chain or record of the hashing, which may, e.g., be used to inform the application of a current hashing scheme to a current input image, identify that a previous version of the modified authentication image may have been intercepted or otherwise maliciously obtained, and/or to obtain other security advantages. In some instances, the DPO system 102 may likewise apply updated and/or different microshifts in the image at such predetermined intervals, and these additional microshifts may be similarly recorded.

At step 206, the first user device 103 may send a first input image to the DPO system 102. For example, the first user device 103 may send an image, a series of images, a video recording, live video footage, and/or other inputs, which may be used to authenticate the user of the first user device to the DPO system 102 (e.g., for purposes of accessing an online portal, application, executing a transaction such as an automated teller machine (ATM) transaction, and/or otherwise). In some instances, the first user device 103 may send the first input image to the DPO system 102 while the first wireless data connection is established.

At step 207, the DPO system 102 may receive the first input image. For example, the DPO system 102 may receive the first input image via the communication interface 113 and while the first wireless data connection is established.

At step 208, the DPO system 102 may modify the first input image. For example, the DPO system 102 may reference the stored history of the microshifts and/or cryptographic hashes applied to the modified authentication image, and may modify the first input image accordingly (e.g., by applying the same microshifts, cryptographic hashes, or the like) to produce a modified first input image.

At step 209, the DPO system 102 may compare the modified authentication image with the modified first input image to identify whether there is a match between the microshifts and hashing of the two images. If there is a match between the modified authentication image and the modified first input image, the DPO system may proceed to step 210 in FIG. 2C. Otherwise, if there is not a match between the modified authentication image and the modified first input image, the DPO system 102 may proceed to step 213 in FIG. 2C.

Referring to FIG. 2C., at step 210, the DPO system 102 may generate a confidence score indicating that an individual represented in the modified first input image matches the individual in the modified authentication image (e.g., to ensure that not only have the microshifts and hashes been matched in the input image, but also that the identity of the individual in the input image is verified). For example, the DPO system 102 may input the modified first input image into the neural network, trained at step 201. Based on this modified first input image, the neural network may identify stored correlations between features, characteristics, and/or other aspects of the modified first input image and identities, which the neural network was trained to detect. In these instances, the neural network may identify whether the identified identity matches an anticipated identity (e.g., the identity of the individual represented in the modified authentication image) or not (e.g., an individual or bot may be trying to impersonate the individual). Based on a degree to which the identities match, the DPO system 102 may produce a confidence score (e.g., with a higher confidence score indicating a higher likelihood that the individual is authentic and a lower confidence score indicating a lower likelihood of such authenticity (i.e., that the modified input image likely includes some impersonation, deepfake, or the like).

In some instances, where the input image is a video recording, live video, or the like, the neural network may take into account a responsiveness of the camera to a user's face in producing the confidence score. For example, the neural network may identify whether an amount of time elapsed between initiating the video and the video centering or otherwise focusing on the users face meets or exceeds some threshold amount of time (which may e.g., represent an average amount of time elapsed for a human being to do so). In these instances, if the neural network determines that the amount of elapsed time meets or exceeds the amount of time, it may weight the confidence score accordingly (e.g., increase the confidence score by some predetermined amount, or the like). In contrast, if the neural network determines that the amount of time elapsed fails to meet or exceed the amount of time, it may decrease the confidence score accordingly (e.g., reduce the confidence score by some predetermined amount, or the like), as this may be indicative of a bot, deepfake, or other automated impersonation.

In some instances, the DPO system 102 may continuously and dynamically refine and/or otherwise retrain the neural network based on new input images, user feedback, and/or otherwise. For example, in doing so, the DPO system 102 may cause the neural network to continuously improve its ability to perform authentication via facial recognition and/or other image processing techniques.

At step 211, the DPO system 102 may compare the confidence score to a predetermined confidence threshold. In instances where the confidence score meets or exceeds the confidence threshold, the DPO system 102 may proceed to step 212. Otherwise, if the confidence score fails to meet or exceed the confidence threshold, the DPO system 102 may proceed to step 213.

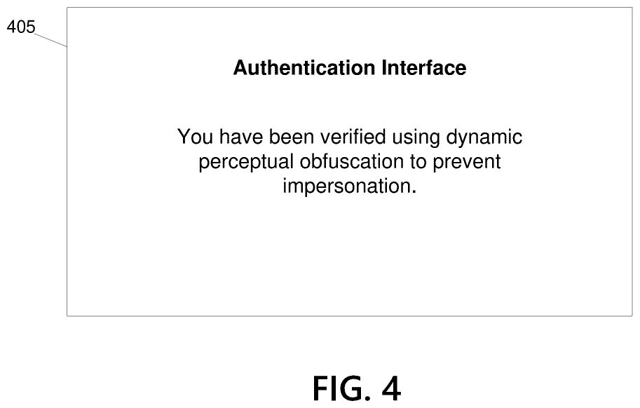

At step 212, the DPO system 102 may validate the first input image. For example, the DPO system 102 may validate an identity of the user of the first user device 103, and may authorize them to perform one or more actions accordingly (e.g., successful login, access online portal, access application, and/or perform other actions). In some instances, the DPO system 102 may send a notification that the identity has been validated to the first user device 103 (along with commands which may, e.g., cause the first user device 103 to display the notification accordingly). For example, the first user device 103 may display a graphical user interface similar to graphical user interface 405, which is shown in FIG. 4.

At step 213, the DPO system 102 may execute one or more response actions based on identifying the impersonation at step 211 or determining there is not a match between the modified authentication image and the modified first input image at step 209. For example, the DPO system 102 may send one or more notifications to administrator computing devices, user devices of the impersonated user, and/or otherwise, which may, e.g., flag the input image, initiate discovery into the input image, or the like. Additionally or alternatively, the DPO system 102 may initiate one or more actions to block future traffic from the corresponding user device, quarantine the user device, and/or perform other actions with regard to the user device. In some instances, where the microshifts and/or hashing of the input image does not match the microshifts and/or hashes of the authentication image, the DPO system 102 may identify whether the microshifts and/or hashing of the input image matches a previous iteration of the microshifts and/or hashing. For example, the DPO system 102 may reference the stored record of these modifications to make such identification. In these instances, if the DPO system 102 identifies that the modifications match a previous iteration, the DPO system 102 may identify that a previously stored iteration of the authentication image may have been compromised, and is being used in an attempt to illicitly authenticate on behalf of the corresponding user. In these instances, the DPO system 102 may mark this iteration of the authentication image invalid, and may add the iteration to a list of known invalid authentication images, which may, e.g., be referenced in future authentication attempts.

Additionally or alternatively, the DPO system 102 may cause the input image to deteriorate and/or cause other degradation to the input image at the corresponding user device itself, which may, e.g., render the input image ineffective for future authentication attempts. For example, this may be triggered upon opening the input image outside the network. In some instances, the DPO system 102 may apply one or more scrambling and/or other expiring mechanisms to the input image. In some instances, such measures may be initiated by an outer encryption layer imposed on the input image by the DPO system 102, which may, e.g., cause these measures to be triggered when the input image is opened on an external network.

With reference to FIG. 2D, at step 214, the second user device 104 may establish a connection with the DPO system 102. For example, the second user device 104 may establish a second wireless data connection with the DPO system 102 to link the second user device 104 with the DPO system 102 (e.g., in preparation for sending input images). In some instances, the second user device 104 may identify whether a connection is already established with the DPO system 102. If a connection is already established with the DPO system 102, the second user device 104 might not reestablish the connection. If a connection is not yet established with the DPO system 102, the second user device 104 may establish the second wireless data connection as described herein.

At step 215, the second user device 104 may send a second input image to the DPO system 102. For example, the second user device 104 may send an image similar to the first input image sent by the first user device 103, as is described above. For illustrative purposes, however, it may be assumed that the second user device 104 may be operated by a user, bot, or the like, which may intend to impersonate a user of the first user device 103. For example, the second input image may include a deepfake image, and/or other intercepted image that may include or otherwise intend to represent the user of the first user device 103. In some instances, the second user device 104 may send the second input image while the second wireless data connection is established.

At step 216, the DPO system 102 may receive the second input image sent at step 215. For example, the DPO system 102 may receive the second input image via the communication interface 113 and while the second wireless data connection is established.

At step 217, the DPO system 102 may modify the second input image. For example, the DPO system 102 may modify the second input image according to the microshifts, hashes, and/or other modifications made to the modified authentication image at step 204. For example, the DPO system 102 may perform actions similar to those described at step 208 with regard to the first input image.

At step 218, the DPO system 102 may compare the modified second input image to the modified authentication image. For example, the DPO system 102 may perform actions to those performed at step 205 with regard to the comparison between the modified first input image and the modified authentication image. In this case, however, the DPO system 102 may identify there is not a match between the modified second input image and the modified authentication image. Accordingly, the DPO system 102 might not proceed to the step of validating an identity of the user depicted in the modified second input image, and instead may return to step 213 to execute the response action.

Although the above described event sequence relates primarily to the authentication of individuals using facial recognition technologies, any other types of images (e.g., check images, document scans, and/or other images) may be modified and authenticated using similar techniques without departing from the scope of the disclosure.

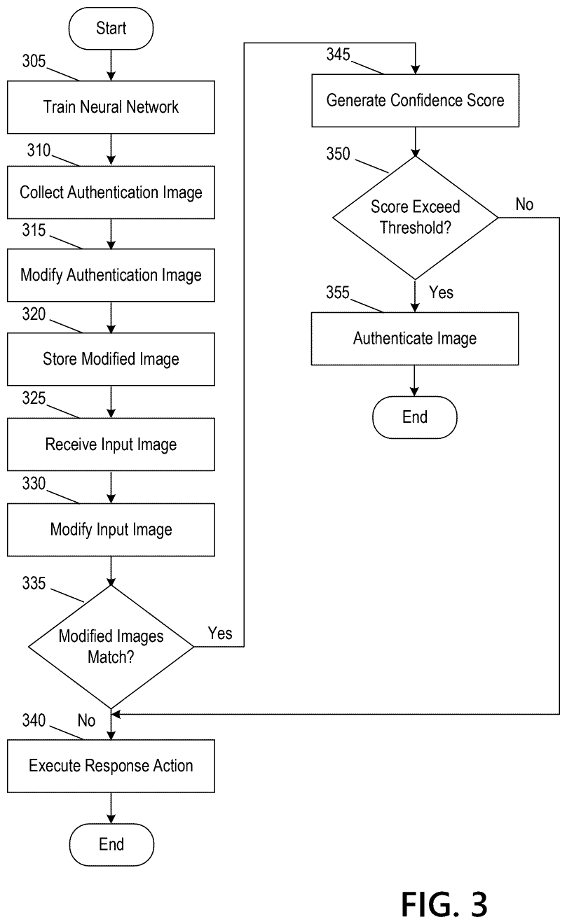

FIG. 3 depicts an illustrative method for using overclocked image feature hashing and dynamic perceptual obfuscation for machine resistant image capture in accordance with one or more example embodiments. Referring to FIG. 3, at step 305, a computing platform comprising one or more processors, memory, and a communication interface may train a neural network for identity verification. At step 310, the computing platform may collect an authentication image for use in verifying a given user. At step 315, the computing platform may modify the authentication image by applying one or more microshifts, cryptographic hashes, and/or other modifications. At step 320, the computing platform may store the modified authentication image. At step 325, the computing platform may receive an input image for use in verifying the user. At step 330, the computing platform may modify the input image using the same microshifts, cryptographic hashes, and/or other modifications that were applied at step 315 to the authentication image. At step 335, the computing platform may identify whether the modified input image matches the modified authentication image. If the images do not match, the computing platform may proceed to step 340, where a response action may be executed by the computing platform. If the images do match, the computing platform may proceed to step 345. At step 345, the computing platform may generate a confidence score indicating a likelihood of identity verification in the modified input image. At step 350, the computing platform may compare the confidence score to a confidence threshold. If the confidence score meets or exceeds the threshold, the computing platform may proceed to step 355, where the computing platform may authenticate the input image. Otherwise, if the confidence score fails to meet or exceed the threshold, the computing platform may return to step 335 to execute a response action.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
apply a microshift to an authentication image associated with a user;
hash the microshifted authentication image to produce a modified authentication image;
receive a request to authenticate the user, wherein the request includes an input image for identity verification;
apply the microshift and the hash to the input image to produce a modified input image;
compare the modified input image to the modified authentication image;
based on identifying a match between the modified input image and the modified authentication image, generate, using a neural network, a confidence score indicating a likelihood that the modified input image depicts the user;
compare the confidence score to a confidence threshold; and
based on identifying that the confidence score meets or exceeds the confidence threshold, authenticate the user.

2. The computing platform of claim 1, wherein applying the microshift comprises modifying one or more of: pixel alignment, light refraction, or texture mapping.

3. The computing platform of claim 1, wherein the microshift is detectable by machines, and imperceptible to a human eye.

4. The computing platform of claim 1, wherein the memory stores additional computer readable instructions that, when executed by the at least one processor, cause the computing platform to:
continuing to hash, at a predetermined interval, the modified input image, wherein a record of the hashing is maintained by the computing platform, and wherein further input images are authenticated by applying the microshift and hashing the further input images according to the record.

5. The computing platform of claim 1, wherein the memory stores additional computer readable instructions that, when executed by the at least one processor, cause the computing platform to:
based on identifying that the modified input image fails to match the modified authentication image, execute one or more response actions.

6. The computing platform of claim 5, wherein executing the one or more response actions comprises causing the input image to degrade at a source of the input image.

7. The computing platform of claim 1, wherein the memory stores additional computer readable instructions that, when executed by the at least one processor, cause the computing platform to:
based on identifying that the confidence score fails to meet or exceed the confidence threshold, execute one or more response actions.

8. The computing platform of claim 1, wherein the input image comprises one of: an image, a video recording, or a live video feed.

9. The computing platform of claim 1, wherein the memory stores additional computer readable instructions that, when executed by the at least one processor, cause the computing platform to:
update, via a dynamic feedback loop and using the input image, the neural network.

10. The computing platform of claim 1, wherein the microshift renders the authentication image impossible to scan or replicate.

11. A method comprising:
at a computing platform comprising at least one processor, a communication interface, and memory:
applying a microshift to an authentication image associated with a user;
hashing the microshifted authentication image to produce a modified authentication image;
receiving a request to authenticate the user, wherein the request includes an input image for identity verification;
applying the microshift and the hash to the input image to produce a modified input image;
comparing the modified input image to the modified authentication image;
based on identifying a match between the modified input image and the modified authentication image, generating, using a neural network, a confidence score indicating a likelihood that the modified input image depicts the user;
comparing the confidence score to a confidence threshold; and
based on identifying that the confidence score meets or exceeds the confidence threshold, authenticating the user.

12. The method of claim 11, wherein applying the microshift comprises modifying one or more of: pixel alignment, light refraction, or texture mapping.

13. The method of claim 11, wherein the microshift is detectable by machines, and imperceptible to a human eye.

14. The method of claim 11, further comprising:
continuing to hash, at a predetermined interval, the modified input image, wherein a record of the hashing is maintained by the computing platform, and wherein further input images are authenticated by applying the microshift and hashing the further input images according to the record.

15. The method of claim 11, further comprising:
based on identifying that the modified input image fails to match the modified authentication image, executing one or more response actions.

16. The method of claim 15, wherein executing the one or more response actions comprises causing the input image to degrade at a source of the input image.

17. The method of claim 11, further comprising:
based on identifying that the confidence score fails to meet or exceed the confidence threshold, executing one or more response actions.

18. The method of claim 11, wherein the input image comprises one of: an image, a video recording, or a live video feed.

19. The method of claim 11, further comprising:
updating, via a dynamic feedback loop and using the input image, the neural network.

20. One or more non-transitory computer-readable media storing instructions that, when executed by a computing platform comprising at least one processor, a communication interface, and memory, cause the computing platform to:
apply a microshift to an authentication image associated with a user;
hash the microshifted authentication image to produce a modified authentication image;
receive a request to authenticate the user, wherein the request includes an input image for identity verification;
apply the microshift and the hash to the input image to produce a modified input image;
compare the modified input image to the modified authentication image;
based on identifying a match between the modified input image and the modified authentication image, generate, using a neural network, a confidence score indicating a likelihood that the modified input image depicts the user;
compare the confidence score to a confidence threshold; and
based on identifying that the confidence score meets or exceeds the confidence threshold, authenticate the user.
